(19) United States
(12) Patent Application Publication
(10) Pub. No.: US 2016/0173756 A1
(43) Pub. Date: Jun. 16, 2016

(54) FOCUS CONTROL DEVICE AND METHOD AND IMAGING APPARATUS

(71) Applicant: Hitachi Industry & Control Solutions, Ltd., Hitachi-shi (JP)

(72) Inventors: Iori UMEZAWA, Hitachi-shi (JP); Hideharu ONO, Hitachi-shi (JP); Tomoaki NISHIGUCHI, Hitachi-shi (JP); Toshiyuki YOKOYAMA, Hitachi-shi (JP); Toshifumi INOKUCHI, Hitachi-shi (JP); Yukitoshi SHIROTA, Hitachi-shi (JP)

(21) Appl. No.: 14/940,229

(22) Filed: Nov. 13, 2015

(30) Foreign Application Priority Data
Dec. 16, 2014 (JP) 2014-253918

(51) Int. Cl. H04N 5/232; G02B 7/09

(52) U.S. Cl. CPC H04N 5/23212; H04N 5/23287; G02B 7/09

(57) ABSTRACT

A controller sets a plurality of detection regions within an imaging area. The controller then compares a difference in a contrast signal level between a maximum contrast signal level and a minimum contrast signal level calculated from among contrast signal levels of contrast signals generated for the plurality of detection regions with a level difference threshold. The controller then sets a priority level in subject information concerning a subject on the basis of a comparison result. The controller then stores the subject information in a storage unit in accordance with the priority level set in the subject information. The controller then drives a focus lens on the basis of the subject information read from the storage unit so as to bring the focus lens into focus.

### BACKGROUND OF THE INVENTION

1. Field of the Invention

The present invention relates to a focus control device and method and an imaging apparatus for performing auto focus control for a subject.

2. Description of the Related Art

Hitherto, an auto focus (AF) function of automatically adjusting the focus of a lens is provided in many imaging apparatuses provided with video recorders, such as surveillance cameras and digital versatile disc (DVD) cameras. One of the focusing methods used in an AF function is a contrast AF method in which the focus is adjusted by detecting a position of a contrast signal of an imaging subject at which the amplitude is maximized.

In an imaging apparatus, by shifting a focus lens in the optical axis direction thereof, an imaging subject is set in the focusing state or the non-focusing state, and in accordance with the movement of the focus lens, the amplitude of a contrast signal of the imaging subject also changes. Thus, in a basic contrast AF method, an imaging subject is focused in the following manner. The focus lens is shifted in the optical axis direction thereof, and then, the direction in which an imaging subject will be focused is detected on the basis of the magnitudes of the amplitude of a contrast signal before and after the focus lens has been shifted. Then, the focus lens is shifted in the detected direction so as to focus the imaging subject. In the following description, performing control for bringing a focus lens into focus by using an AF function will be referred to as “AF control”, the state in which a focus lens is being shifted under AF control or in which processing is being performed for executing the AF function will be referred to as “AF operation”, and the state in which the shifting of the focus lens is suspended while the AF function is in execution will be referred to as “AF standby”.

The contrast level in this contrast AF method is determined by the type of subject. A situation where a low contrast subject is imaged will be discussed below with reference to FIGS. 13 and 14.

FIG. 13 illustrates an example of a low contrast subject 102 to be imaged within an imaging area 100 by a known imaging apparatus in the night. This imaging area 100 is substantially the same size as an output screen of a display connected to the imaging apparatus. FIG. 14 is a graph illustrating a contrast signal level detected when the low contrast subject 102 is imaged by the imaging apparatus.

The known imaging apparatus performs the detection of a contrast signal of the low contrast subject 102 (for example, a tower building) within a detection region 101 around the center of the imaging area 100. In the night, however, since the low contrast subject 102 is dark and the background is also black, the contour of the low contrast subject 102 blends into the background.

As shown in FIG. 14, the curve of the contrast signal level indicating the sharpness of the low contrast subject 102 is gentle, and it is difficult to find a focal point, which is the peak of the contrast signal level, even if the imaging apparatus shifts the focus lens in the optical axis direction. In such a situation, focus hunting may occur in the focus lens, or the AF function may stop without obtaining a focal point.

Because of the above-described reasons, in a surveillance camera utilizing the contrast AF method, it is difficult to focus a subject, such as a wall of a building having a solid color or the sky, and particularly in a dark place, a focal point is difficult to find, as shown in FIG. 14. Accordingly, in the case of the imaging of a low contrast subject, there is a demand for suppressing the occurrence of hunting and for speedily shifting a focus lens to or near a focal point.

Japanese Unexamined Patent Application Publication No. 11-38309 discloses the following technology. Lens-to-subject distance mode values corresponding to multiple typical zoom positions of a zoom lens are stored in a non-volatile memory, and if ranging (distance measuring) is not achieved at a certain zoom position, the lens-to-subject distance mode value corresponding to this zoom position is read from the non-volatile memory so as to adjust the focal point. As the lens-to-subject distance mode value, the average of past focusing positions for each magnification factor of a camera is determined from records concerning the focusing positions.

### SUMMARY OF THE INVENTION

In the technology disclosed in the above-described publication, if ranging is achieved for a currently imaging subject, the distance from the lens to this subject is stored in the non-volatile memory as a past focusing position for calculating lens-to-subject distance mode values used for subsequent AF operations. In this manner, every time ranging is achieved for a certain subject, distance information concerning this subject determined from the position at which the focus lens has stopped at the end of the AF operation is stored in the non-volatile memory. Accordingly, even if the distances of subjects imaged with the same magnification factor are very different, the lens-to-subject distance mode value is determined from the average of such different focusing positions. As a result, the determined lens-to-subject distance mode value is far from the actual focal point.

Thus, in a known imaging apparatus, even if the focal point of the focus lens is determined by referring to the lens-to-subject distance mode value, it is difficult to actually focus a subject for which ranging is not achieved. Additionally, there is no correlation between subjects for which ranging is achieved and subjects for which ranging is not achieved. Accordingly, when a subject for which ranging is not achieved is imaged by a known imaging apparatus, it is possible that the detected lens-to-subject distance mode value for such a subject may not be the actual focusing position.

The present invention has been made in view of the above-described background. It is an object of the invention to perform appropriate focus control for a low contrast subject.

A focus control device according to an embodiment of the present invention includes a driving unit, a signal generator, and a controller. The driving unit drives a focus lens to focus a subject. The signal generator generates a contrast signal for each of a plurality of detection regions set within an imaging area of an imaging unit from an imaging signal corresponding to each of the plurality of detection regions. The imaging signal is output as a result of the imaging unit imaging an optical image of the subject which is formed in the imaging unit via the focus lens. The controller sets the plurality of detection regions within the imaging area. The controller than compares a difference in a contrast signal level between a maximum contrast signal level and a minimum contrast signal level calculated from among contrast signal levels of the contrast signals generated for the plurality of detection regions with a level difference threshold, and sets a priority level in subject information concerning the subject on the basis of a comparison result. The controller then stores the subject information in a storage unit in accordance with the priority level set in the subject information. The controller then controls the driving unit on the basis of the subject information read from the storage unit so as to bring the focus lens into focus.

The above-described object is also achieved by an imaging apparatus including the above-described focus control device and by a focus control method employed in the above-described focus control device.

According to an embodiment of the invention, it is possible to appropriately drive a focus lens in accordance with a priority level based on a contrast signal level calculated for each of a plurality of detection regions. For example, the controller preferentially stores subject information obtained from a low contrast subject in the storage unit, and speedily drives the focus lens to a position which is assumed to be near a focal point, on the basis of this subject information. It is thus possible to decrease the time taken to bring the focus lens into focus.

Other features, elements, characteristics and advantages of the present invention will become more apparent from the following detailed description of embodiments of the present invention.

### BRIEF DESCRIPTION OF THE DRAWINGS

FIG. 1 is a block diagram illustrating the overall configuration of an imaging apparatus according to an embodiment of the invention;

FIG. 2 illustrates an example of a first detection region within an imaging area according to an embodiment of the invention;

FIG. 3 illustrates examples of second detection regions according to an embodiment of the invention;

FIGS. 4A through 4C illustrate an example of a first low contrast subject according to an embodiment of the invention: FIG. 4A illustrates an example of a first low contrast subject; FIG. 4B illustrates an example of a contrast signal level within a first detection region; and FIG. 4C illustrates examples of second detection regions;

FIGS. 5A through 5C illustrate an example of a second low contrast subject according to an embodiment of the invention: FIG. 5A illustrates an example of a second low contrast subject; FIG. 5B illustrates an example of a contrast signal level within a first detection region; and FIG. 5C illustrates examples of second detection regions;

FIGS. 6A through 6C illustrate an example of an auxiliary contrast subject according to an embodiment of the invention: FIG. 6A illustrates an example of an auxiliary contrast subject; FIG. 6B illustrates an example of a contrast signal level within a first detection region; and FIG. 6C illustrates examples of second detection regions;

FIG. 7 illustrates examples of first through third priority levels assigned to subjects by a controller according to an embodiment of the invention;

FIG. 8 illustrates examples of a temporary subject information storage area, a subject information storage area, a distance information table, and thresholds in a memory according to an embodiment of the invention;

FIG. 9 illustrates an example of the configuration of a subject information table according to an embodiment of the invention;

FIG. 10 illustrates the relationship between a third threshold and a fourth threshold used for selecting subject information to be stored in a subject information storage area by a controller according to an embodiment of the invention;

FIGS. 11 and 12 are first and second flowcharts illustrating a processing example of AF operation performed by an imaging apparatus according to an embodiment of the invention;

FIG. 13 illustrates an example of a subject to be imaged within an imaging area by a known imaging apparatus in the night; and

FIG. 14 is a graph illustrating a contrast signal level detected when a low contrast subject is imaged by a known imaging apparatus.

### DESCRIPTION OF THE PREFERRED EMBODIMENTS

An imaging apparatus and a focus control device according to an embodiment of the invention will be described below with reference to the accompanying drawings.

In the specification and drawings, elements having substantially the same function or the same configuration are designated by like reference numerals, and an explanation thereof will be given only once.

### (1) Configuration of Imaging Apparatus

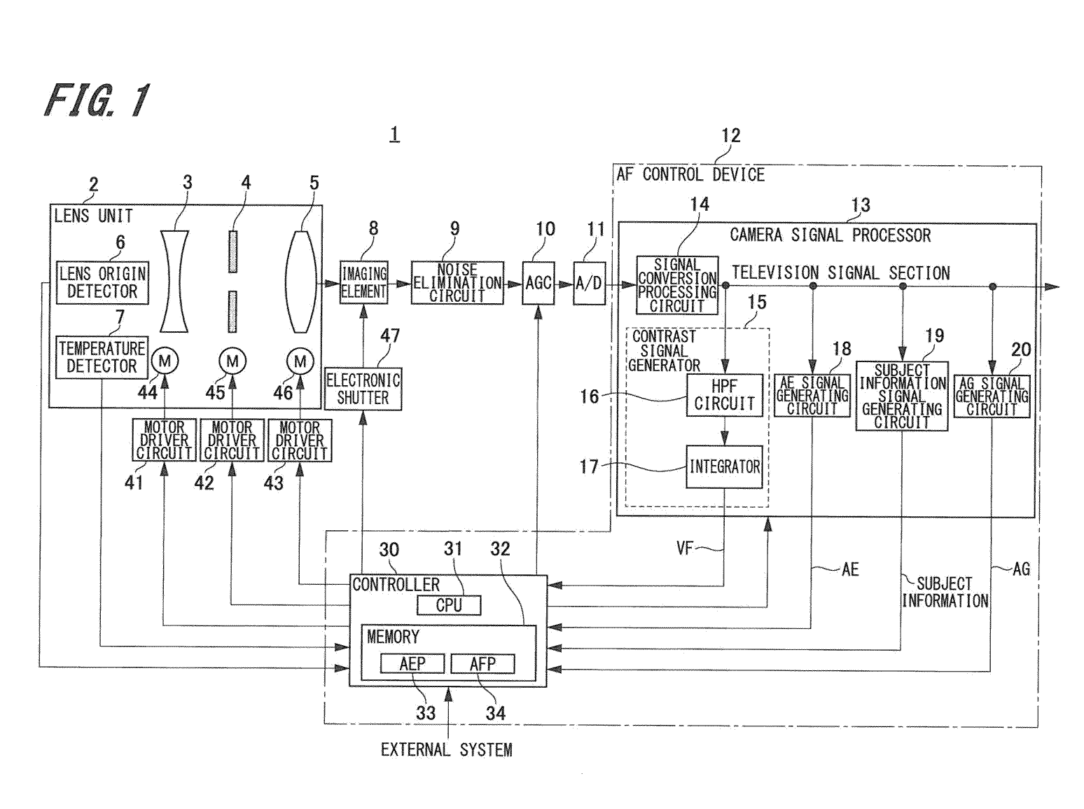

FIG. 1 is a block diagram illustrating the overall configuration of an imaging apparatus 1 of this embodiment.

The imaging apparatus 1 includes a lens unit 2, an imaging element 8, a noise elimination circuit 9, an auto gain control (AGC) circuit 10, an analog-to-digital (A/D) conversion circuit 11, and an auto focus (AF) control device 12. The imaging apparatus 1 also includes motor driver circuits 41 through 43 and an electronic shutter 47. The imaging apparatus 1 is used as, for example, a surveillance camera. However, the imaging apparatus 1 may be used as a personal camera or may be built in a cellular phone. In FIG. 1, the AGC circuit 10 is shown as “AGC”, and the A/D conversion circuit 11 is shown as “A/D”.

The lens unit 2 includes a variator lens group 3, a diaphragm 4, and a focus lens group 5 (an example of a focus lens). The variator lens group 3 varies the magnification factor of the luminous flux received from a subject so as to adjust the zoom magnification factor. The diaphragm 4 adjusts the amount of received light. The focus lens group 5 has a focus adjusting function. The lens unit 2 forms an optical image of a subject on the light-receiving surface of the imaging element 8, which is constituted by charge coupled devices (CCDs).

The lens unit 2 also includes a lens origin detector 6, which is constituted by, for example, a photointerrupter, and a temperature detector 7. The lens origin detector 6 detects the absolute positions (reference positions) of the variator lens group 3 and the focus lens group 5, and sends detection results as lens absolute position information to a controller 30 loaded in the imaging apparatus 1 or to an external system which is capable of communicating with the imaging device 1. In the following description, in contrast to the absolute positions of the variator lens group 3 and the focus lens group 5 detected by the lens origin detector 6, the position to which the focus lens group 5 has moved will be referred to as a “focus lens position”. The position of the focus lens group 5 at which a subject is focused will be referred to as a “focusing position”.

The temperature detector 7 detects the temperature within the lens unit 2 and sends detection results as lens unit temperature information to the controller 30 or an external system which is capable of communicating with the imaging device 1. The external system is constituted by, for example, a control computer, and may be able to receive the lens absolute position information or the lens unit temperature information via the controller 30.

The lens unit 2 also includes motors 44 through 46 for driving the variator lens group 3, the diaphragm 4, and the focus lens group 5, respectively. The motors 44 through 46 are driven by motor control signals input from the motor driver circuits 41 through 43, respectively.

The imaging element 8 (an example of an imaging unit) images an optical image formed in an imaging area of the light-receiving surface of the imaging element 8 via the focus lens group 5. The imaging element 8 then performs photoelectric conversion on this optical image and outputs a resulting electric signal (imaging signal) to the noise elimination circuit 9. The imaging signal is subjected to predetermined noise elimination processing in the noise elimination circuit 9 and is then amplified to an optimal level in the AGC circuit 10. The imaging signal is then converted into a digital signal in the A/D conversion circuit 11 and is output to a camera signal processor 13 as a digital imaging signal.

The AF control device 12 includes the camera signal processor 13 and the controller 30.

The camera signal processor 13 includes a signal conversion processing circuit 14, a contrast signal generator 15, an auto exposure (AE) signal generating circuit 18, a subject information signal generating circuit 19, and an auto gain (AG) signal generating circuit 20.

The signal conversion processing circuit 14 performs predetermined signal processing on the digital imaging signal input from the A/D conversion circuit 11. In this case, the signal conversion processing circuit 14 converts the digital imaging signal into a standard television signal compliant with a television system, for example, the National Television Standards Committee (NTSC) standards or the Phase Alternating Line (PAL) standards, and outputs the converted television signal to an external source, for example, an external system which communicates with the imaging device 1 via a network. In the external system, an image based on the television signal is displayed on a screen of a display.

The contrast signal generator 15 (an example of a signal generator) includes a high pass filter (HPF) circuit 16 and an integrator 17. The HPF circuit 16 may change the value of a cutoff frequency as desired. The HPF circuit 16 then generates signals having a frequency higher than the cutoff frequency and outputs the generated signals to the integrator 17. The integrator 17 outputs a contrast signal VF obtained by integrating the signals received from the HPF circuit 16 to the controller 30. The contrast signal generator 15 constituted by the HPF circuit 16 and the integrator 17 may obtain values from the regions of a television signal. Combinations of the HPF circuit 16 and the integrator 17 may be provided in association with second detection regions (examples of a plurality of detection regions) set in the imaging area of the imaging device 8, as shown in FIG. 3, which will be discussed later.

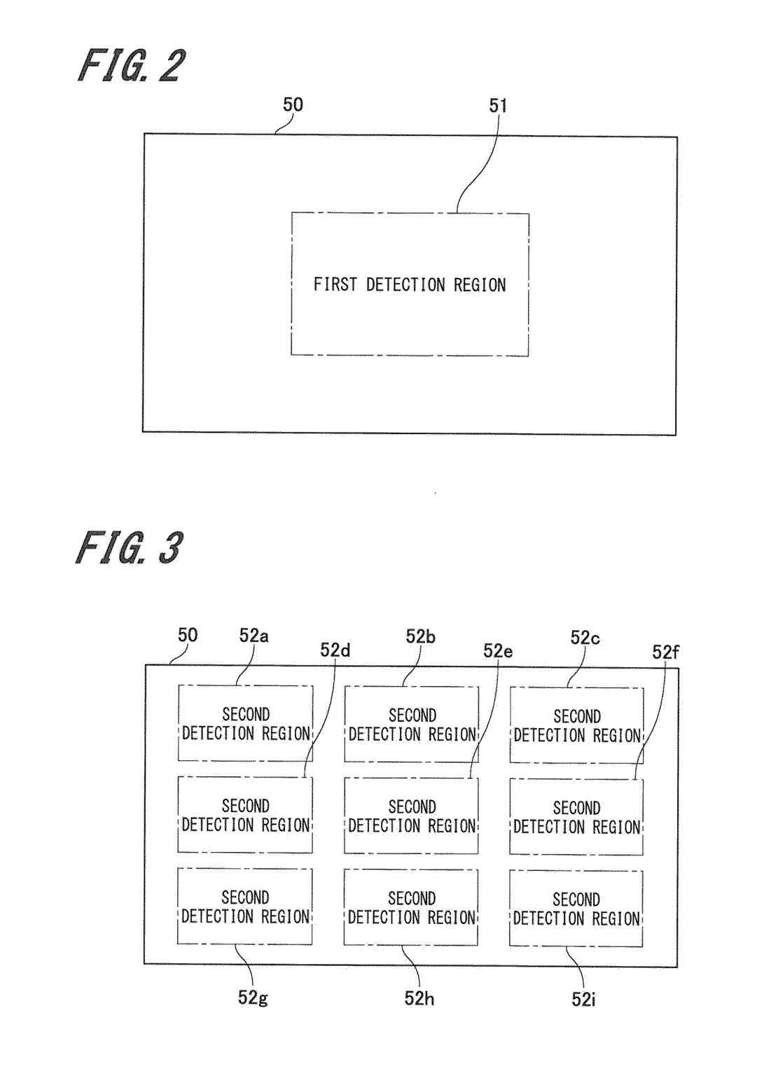

The detection regions from which the contrast signal generator 15 generates contrast signals will be discussed below with reference to FIGS. 2 and 3.

FIG. 2 illustrates an example of a first detection region 51 within an imaging area 50 according to the embodiment. A television signal output from the imaging apparatus 1 is displayed on the output screen of a display of an external system. That is, an image captured within the imaging area 50 is displayed on the output screen. The first detection region 51 is formed in a rectangular frame-like shape and is provided around the center of the imaging area 50. The contrast signal generator 15 detects the contrast of the subject within the first detection region 51 and generates a contrast signal.

FIG. 3 illustrates examples of second detection regions 52a through 52i within the imaging area 50. The contrast signal generator 15 generates contrast signals for the nine second detection regions 52a through 52i (examples of a plurality of detection regions) set within the imaging area 50 from imaging signals corresponding to the nine second detection regions 52a through 52i. The controller 30 then determines the levels of the contrast signals for the second detection regions 52a through 52i. The levels of the contrast signals are used for determining by the controller 30 whether or not a subject is a low contrast subject and for setting a predetermined priority level in subject information concerning this subject. This will be discussed in greater detail later. The controller 30 then stores the subject information in a memory 32 in accordance with the priority level set in the subject information.

A description will be back to the configuration and the operation of the imaging apparatus 1 shown in FIG. 1.

By using the HPF circuit 16, the contrast signal generator 15 extracts high-frequency components of luminance signals in the first detection region 51 of the television signal (captured image) generated by the signal conversion processing circuit 14. High-frequency components of a luminance signal in a certain detection region may be extracted by taking the difference between a luminance signal (luminance value) output from a certain pixel within this detection region and a luminance signal output from an adjacent pixel or a pixel separated from this certain pixel by a predetermined number of pixels. This extraction processing is performed for all pixels within the first detection region 51. Then, the camera signal processor 13 integrates the extracted high-frequency components of the luminance signals of all the pixels within the first detection region 51 by using the integrator 17 so as to generate a contrast signal VF. The camera signal processor 13 then outputs the generated contrast signal VF to the controller 30.

On the basis of the input television signal, the AE signal generating circuit 18 generates an auto iris signal AE having a signal level that reflects the current brightness of a captured image, the degree of the opening of the diaphragm 4 of the lens unit 2, and the gain of the AGC circuit 10, and outputs the generated auto iris signal AE to the controller 30.

The subject information signal generating circuit 19 extracts, for example, a color signal, from the entire television signal or a certain region of the television signal, and outputs the subject information to the controller 30. The subject information indicates, for example, the contrast value, color signal, subject distance, and luminance signal of a subject.

On the basis of the input television signal, the AG signal generating circuit 20 generates an AG signal for controlling the gain of the AGC circuit 10 and outputs the generated AG signal to the controller 30.

The controller 30 includes information processing resources, such as a central processing unit (CPU) 31 for controlling the individual elements of the imaging apparatus 1 and a non-volatile memory 32 (an example of a storage unit). In the memory 32, a program for implementing the functions according to this embodiment, parameters used for this program, and data generated by the execution of this program are stored. In the memory 32, an auto iris data processing program (AEP) 33 and an AF data processing program (AFP) 34, for example, are stored. In the memory 32, items of data shown in FIG. 8, which will be discussed later, are also stored. The processing performed by the controller 30 is implemented as a result of the CPU 31 reading the program, parameters, and data from the memory 32 and executing predetermined processing.

The controller 30 also receives a control command from an external system which is connected to the imaging apparatus 1 via a communication interface (not shown). The memory 32 also has a function as a buffer memory which temporarily stores image data indicating a captured image in units of frames. Alternatively, a buffer memory may be provided separately from the memory 32. The memory 32 may be provided outside of the imaging apparatus 1 and the AF control device 12.

The controller 30 calls the AEP 33 from the memory 32 and determines the current brightness of a captured image from the auto iris signal AE generated in the AE signal generating circuit 18. The controller 30 also calls the AFP 34 from the memory 32 and calculates an auto iris evaluation value, which is an evaluation value for the degree of the opening of the diaphragm 4 and the gain of the AGC circuit 10, from the auto iris signal AE. The controller 30 also obtains an AF evaluation value indicating the value of the contrast signal VF generated in the contrast signal generator 15.

The controller 30 also instructs the contrast signal generator 15 to set the second detection regions 52a through 52i within the imaging area 50. The controller 30 also adds the subject distance corresponding to a focusing position when the focus lens group 5 is in focus to the subject information received from the subject information signal generating circuit 19. The controller 30 then executes processing for storing the subject information in the memory 32. Details of this processing will be discussed later.

The controller 30 then controls a driving unit on the basis of the subject information read from the memory 32 so as to bring the focus lens group 5 into focus. For performing this operation, the controller 30 respectively generates first and second motor control signals for controlling the driving of the variator lens group 3 and the diaphragm 4, and respectively outputs the first and second motor control signals to the motor driver circuits 41 and 42. The first and second motor control signals are generated on the basis of the auto iris evaluation value, zoom magnification factor information indicating the current zoom magnification factor obtained from the lens absolute position information, lens unit temperature information, and trace curve data stored in the memory 32. The driving of the variator lens group 3 and the diaphragm 4 may be controlled by using a known technique.

The motor driver circuit 41 controls the driving of the motor 44 which shifts the variator lens group 3 of the lens unit 2 in the optical axis direction, on the basis of the received first motor control signal. The motor driver circuit 42 controls the driving of the motor 45 which drives the diaphragm 4 of the lens unit 2, on the basis of the received second motor control signal. In this manner, auto iris control is performed. When generating the first and second motor control signals, the controller 30 utilizes the lens unit temperature information so as to enhance the precision of auto iris control.

The controller 30 also controls the shutter speed of the electronic shutter 47 on the basis of the auto iris evaluation value so as to adjust the amount of light for an optical image of a subject to be formed on the light-receiving surface of the imaging element 8. The controller 30 also adjusts the gain in the AGC circuit 10 on the basis of the auto iris evaluation value.

The controller 30 also detects the focusing direction and the focusing position on the basis of the AF evaluation value, and also generates a third motor control signal and sends it to the motor driver circuit 43 (an example of a driving unit). The motor driver circuit 43 controls the driving of the motor 46 (an example of a driving unit) which shifts the focus lens group 5 of the lens unit 2 in the optical axis direction, on the basis of the third motor control signal. In this manner, the motor driver circuit 43 and the motor 46 perform AF control for driving the focus lens group 5 so that the focus lens group 5 can focus on the subject when performing an imaging operation. As the motors 44 through 46, stepper motors, for example, may be used.

### (2) Method for Optimizing Subject Information in Memory

Many known imaging apparatuses used for surveillance purposes are capable of performing panning, tilting, and zooming operations. In most of the imaging apparatuses, the imaging conditions and the types of subjects to be imaged are fixed. Accordingly, the imaging apparatuses are able to tell which subject it is from the brightness of the subject, the brightness around the subject, the contrast value, and the magnification factor.

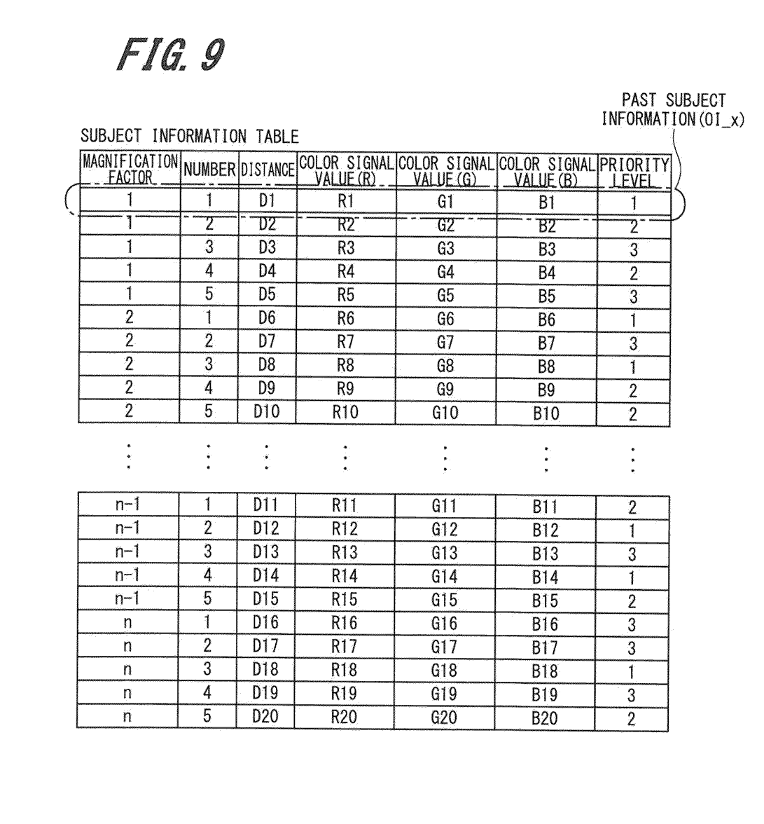

Thus, when performing AF operation, the imaging apparatus 1 of this embodiment optimizes subject information in the memory 32, which will be utilized in a case in which the distance from the imaging apparatus 1 to a currently imaging subject is not measurable. More specifically, after a predetermined restricted number of items of subject information are stored in the memory 32 (a subject information table shown in FIG. 9, which will be discussed later), the controller 30 only selects items of subject information useful for imaging a low contrast subject and stores the selected items of subject information in the memory 32. In the following description, this processing will be referred to as “optimizing”.

In a subject information storage area shown in FIG. 8, which will be discussed later, a plurality of past records concerning the focusing of the focus lens group 5 corresponding to each magnification factor are stored as subject information. In this subject information storage area, items of information concerning subjects which are highly likely to have been successfully focused and to be low contrast subjects are preferentially stored. The reason for this is as follows. When focusing a low contrast subject for which ranging is not achieved, it is appropriate for the imaging apparatus 1 to refer to subject information indicating past records concerning the focusing of low contrast subjects for which ranging has been achieved.

Accordingly, the controller 30 classifies subjects into first low contrast subjects, second low contrast subjects, and auxiliary contrast subjects by using information obtained from an imaging signal at the time of focusing, and also assigns priority levels to the subjects according to the subject type. The controller 30 then stores items of subject information in the subject information storage area according to the priority level.

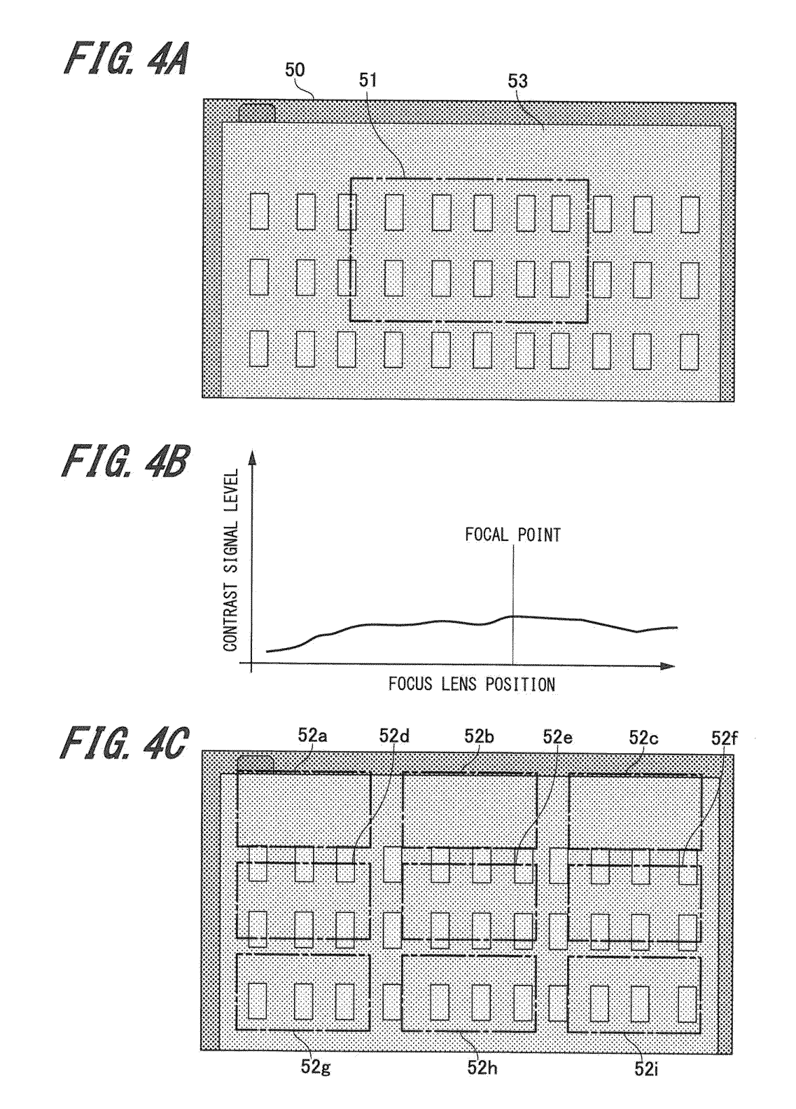

A first low contrast subject, a second low contrast subject, and an auxiliary contrast subject used in this embodiment will now be described below with reference to FIGS. 4A through 6C. It is assumed that the subjects shown in FIGS. 4A through 6C are imaged by the imaging apparatus 1 in the daytime.

FIGS. 4A through 4C illustrate an example of a first low contrast subject. FIG. 4A illustrates a subject 53. FIG. 4B illustrates an example of a contrast signal level within the first detection region 51. FIG. 4C illustrates examples of the second detection regions 52a through 52i, which will be discussed later.

The subject 53 shown in FIG. 4A is, for example, a wall of a building with many windows. Within the first detection region 51 indicated by the contrast signal detection frame shown in FIG. 4A, there is very little change in the color or the brightness. FIG. 4B shows that the level curve of a contrast signal obtained by the controller 30 from the contrast signal generator 15 is gentle. Such a subject 53, will be referred to as a “first low contrast subject”. Under the bright environments, the controller 30 is able to obtain a contrast signal level sufficient for bringing the focus lens group 5 into focus from a first low contrast subject. However, even with a slight change in the environments, such as a change in the brightness, the controller 30 is unable to obtain a contrast signal level sufficient for bringing the focus lens group 5 into focus from a first low contrast subject, so that it is difficult to adjust the focus lens position to a focal point. Thus, although such a subject is suitable as a low contrast subject to be recorded, it may not be suitable for imaging a first low contrast subject by the imaging apparatus 1. The imaging apparatus 1 may have to perform AF control on the basis of subject information stored in the subject information storage area, which will be discussed below, depending on the circumstances.

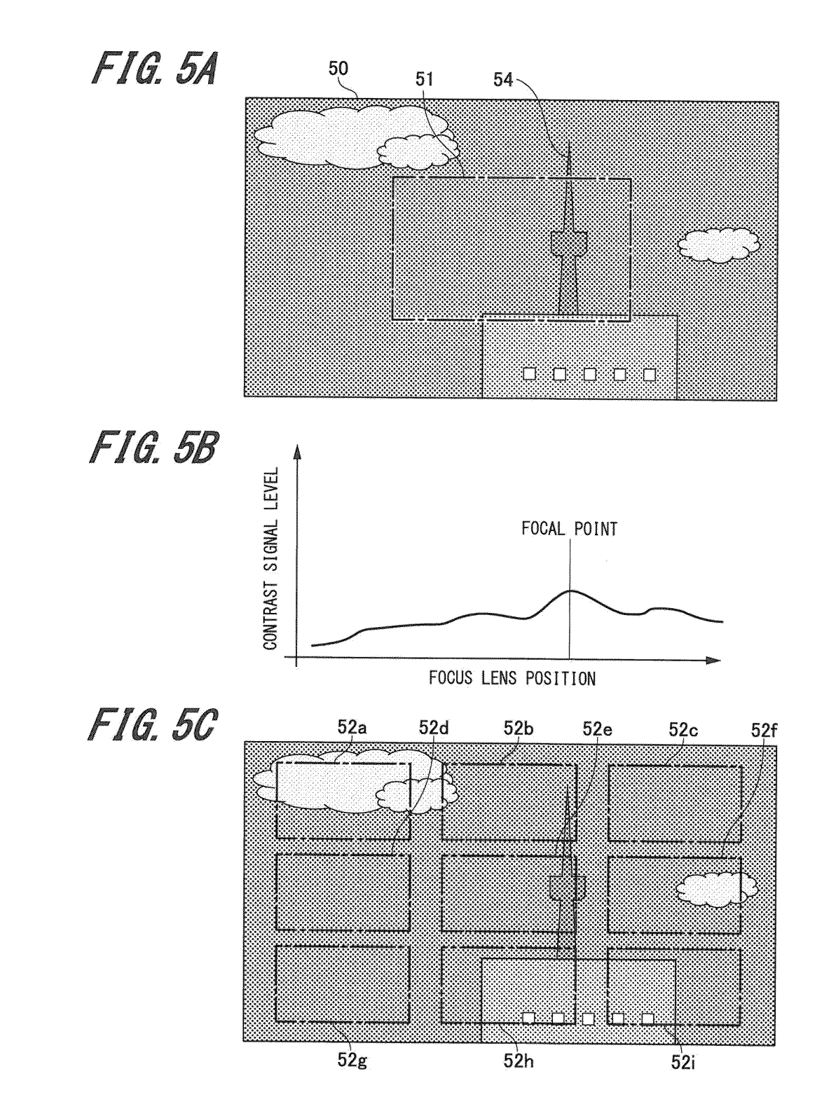

FIGS. 5A through 5C illustrate an example of a second low contrast subject. FIG. 5A illustrates a subject 54. FIG. 5B illustrates an example of a contrast signal level within the first detection region 51. FIG. 5C illustrates examples of the second detection regions 52a through 52i, which will be discussed later.

The subject 54 shown in FIG. 5A is, for example, a tower building against the sky in the daytime. Within the first detection region 51, there are differences in the color and the brightness between the sky and the building. Accordingly, the controller 30 is able to obtain a sufficient contrast signal level from the subject 54 which is captured around the center of the imaging area 50, so that the focus lens group 5 can be brought to focus the subject 54. However, the sky, which is a low contrast portion, occupies a large area of the first detection region 51. In this case, as shown in FIG. 5B, the shape of a contrast signal level is like a mountain having a low peak. Such a subject 54 will be referred to as a “second low contrast subject”. The controller 30 extracts subject information concerning a low contrast portion within the first detection region 51 by using the second detection regions 52a through 52i, which will be discussed later, and then stores low contrast subject information indicating a reliable focusing position in the subject information storage area.

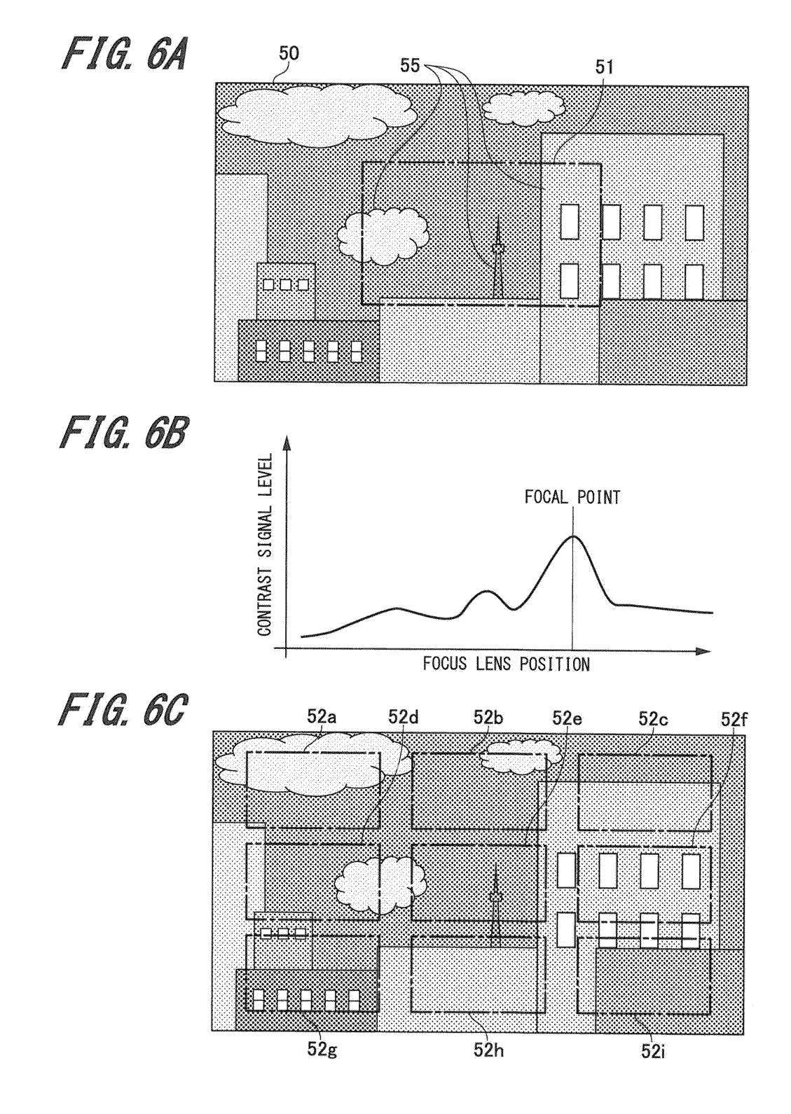

FIGS. 6A through 6C illustrate an example of an auxiliary contrast subject. FIG. 6A illustrates a subject 55. FIG. 6B illustrates an example of a contrast signal level within the first detection region 51. FIG. 6C illustrates examples of the second detection regions 52a through 52i, which will be discussed later.

The subject 55 shown in FIG. 6A is, for example, a tower building, a general building, and clouds against the sky in the daytime. Within the first detection region 51, there are differences in the color and the brightness between the sky and the tower building. In this case, as shown in FIG. 6B, the shape of a contrast signal level is like a mountain having a high peak. Such a subject 55 will be referred to as an “auxiliary contrast subject”. In an auxiliary contrast subject, a low contrast portion does not occupy a large area of the first detection region 51, so that it is easy to focus the focus lens group 5 on the subject 55 by using the contrast AF method. Thus, although the similarity between an auxiliary contrast subject and the above-described first and second low contrast subjects is relatively low, the reliability of the focusing position of the focus lens group 5 is considered to be high. Then, if none of items of subject information concerning first and second low contrast subjects are stored as records in the subject information storage area of the memory 32, the controller 30 utilizes an auxiliary contrast subject as auxiliary information for adjusting the focus lens position.

### (Approach to Recording Subject Information)

An approach to recording subject information in the memory 32 by the controller 30 will be described below.

Upon detecting that the focus lens group 5 is in focus, the controller 30 determines the reliability degree, which represents the degree by which the focus lens group 5 will be in focus when the imaging apparatus 1 performs AF operation, as the numeric value indicating the probability that the focus lens group 5 will be in focus at the completion of AF operation. The reliability degree is calculated by the controller 30 on the basis of the contrast signal level and the records of instructions supplied from the controller 30 to the focus lens group 5 from the start of AF operation to the end of AF operation. Processing for calculating the reliability degree by the controller 30 is known.

Then, the controller 30 compares the calculated reliability degree with a reliability degree threshold (r_th), which is a reference value for determining whether or not the focus lens group 5 is in focus. If the calculated reliability degree is equal to or greater than the reliability degree threshold (r_th), the controller 30 instructs the camera signal processor 13 to switch the first detection region 51 to the second detection regions 52a through 52i and obtains contrast signals and color signal values of the second detection regions 52a through 52i from the camera signal processor 13.

A description will be given of a situation where the controller 30 classifies subjects by using the second detection regions 52a through 52i switched from the first detection region 51 and sets priority levels in subject information.

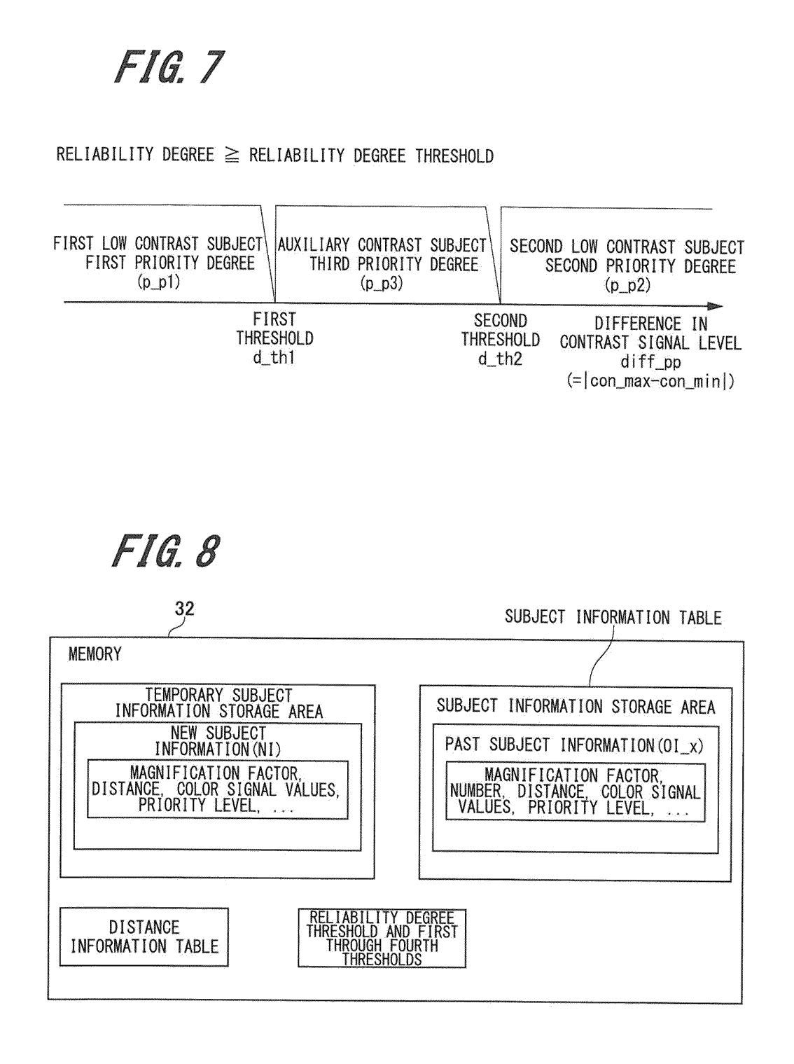

FIG. 7 illustrates examples of first through third priority levels assigned to subjects by the controller 30.

As stated above, the controller 30 classifies subjects having a reliability degree equal to or greater than the reliability degree threshold (r_th) into first low contrast subjects, second low contrast subjects, and auxiliary contrast subjects. The controller 30 then sets one of the first through third priority levels in items of subject information concerning these subjects. For making a determination by the controller 30 as to which of the first through third priority levels will be assigned to each subject, a first threshold (d_th1) and a second threshold (d_th2), which is greater than the first threshold (d_th1), are indicated on a number line shown in FIG. 7. The first threshold (d_th1) and the second threshold (d_th2) are used as examples of level thresholds.

FIG. 8 illustrates examples of a temporary subject information storage area, a subject information storage area, a distance information table, and thresholds in the memory 32.

In the temporary subject information storage area, subject information concerning a subject which is currently imaged by the imaging apparatus 1 is stored. In the subject information storage area, a plurality of items of subject information concerning subjects imaged in the past are stored. In the memory 32, the distance information table and the reliability degree threshold and first through fourth thresholds are also stored. When the imaging apparatus 1 images a subject, the controller 30 stores new subject information (NI) obtained from the contrast signal generator 15 in the temporary subject information storage area.

In the subject information storage area, a subject information table (see FIG. 9, which will be discussed later) in which items of past subject information (OI_x: x=1, 2, 3, . . . n) obtained by the controller 30 from the contrast signal generator 15 are stored. In the distance information table, the relationships between the variator lens group 3 and the focus lens position are stored as distance information. The reliability degree threshold is checked when the controller 30 determines whether or not the first detection region 51 will be switched to the second detection regions 52a through 52i. The first and second thresholds are checked when the controller 30 sets one of the first through third priority levels in subject information. The third and fourth thresholds are checked when the controller 30 determines whether or not new subject information (NI) will be stored in the subject information storage area.

A description will be back to the approach to recording subject information.

The controller 30 determines the difference (diff_pp) between the maximum contrast signal level (con_max) and the minimum contrast signal level (con_min) from contrast signals obtained from the second detection regions 52a through 52i. The difference (diff_pp) may be a value having a positive or negative sign or may be an absolute value.

If the difference in the contrast signal level is smaller than a level difference threshold, the controller 30 sets a higher priority level in the subject information. If the difference in the contrast signal level is equal to or greater than the level difference threshold, the controller 30 sets a lower priority level in the subject information. The controller 30 then preferentially stores subject information with a higher priority level in the memory 32.

In this embodiment, as shown in FIG. 7, the controller 30 compares the difference (diff_pp) in the contrast signal level with the first threshold (d_th1) and the second threshold (d_th2). If the difference (diff_pp) in the contrast signal level is smaller than the first threshold (d_th1), the controller 30 determines that there is almost no difference in the color and the luminance of the subject. Since the contrast of such a subject is uniform in the entire imaging area 50, the subject is determined to be a first low contrast subject. For example, the second detection regions 52a through 52i shown in FIG. 4C have all similar contrast levels, and thus, the controller 30 determines that the subject 53 is a first low contrast subject.

If the subject is determined to be a first low contrast subject, the controller 30 sets a first priority level (p_p1) in priority level information concerning this subject, and obtains distance information from the distance information table on the basis of the focus lens position at the time of the imaging operation. The controller 30 then stores new subject information (NI) including information concerning the color signal values of a region from which the minimum contrast signal level has been obtained, the distance information, and the priority level information in the temporary subject information storage area.

If the difference (diff_pp) in the contrast signal level is equal to or greater than the second threshold (d_th2), as shown in FIG. 7, it means that there may be a portion having a relatively high contrast level and a low contrast portion within the imaging area 50. The controller 30 determines such a subject to be a second low contrast subject. For example, the second detection regions 52c, 52d, and 52g shown in FIG. 5C contain the sky, and the contrast levels of the second detection regions 52c, 52d, and 52g are low (con_min). On the other hand, the second detection regions 52a, 52b, 52e, 52f, 52h, and 52i contain a cloud or a building, and the contrast levels of some of the second detection regions 52a, 52b, 52e, 52f, 52h, and 52i are high (con_max). Thus, the controller 30 determines the subject 54 to be a second low contrast subject.

If the subject is determined to be a second low contrast subject, the controller 30 sets a second priority level (p_p2), which is lower than the first priority level (p_p1), in priority level information concerning this subject, and obtains distance information from the distance information table on the basis of the focus lens position at the time of the imaging operation. The controller 30 then stores new subject information (NI) including information concerning the color signal values of a region from which the minimum contrast signal level has been obtained, the distance information, and the priority level information in the temporary subject information storage area.

If the difference (diff_pp) in the contrast signal level is equal to or greater than the first threshold (d_th1) and is smaller than the second threshold (d_th2), as shown in FIG. 7, the contrast level within the imaging area 50 may be nonuniform. In such a subject, none of the second detection regions 52a through 52i are a solid low contrast region. For example, all the second detection regions 52a through 52i shown in FIG. 6C contain at least one of a building and a cloud having contrast against the sky, and there are no regions that contain only the sky. Accordingly, the controller 30 determines the subject 55 to be an auxiliary contrast subject.

If the subject is determined to be an auxiliary contrast subject, the controller 30 sets a third priority level (p_p3), which is lower than the second priority level (p_p2), in priority level information concerning this subject, and obtains distance information from the distance information table on the basis of the focus lens position at the time of the imaging operation. The controller 30 then stores new subject information (NI) including information concerning the color signal values of a region from which the minimum contrast signal level has been obtained, the distance information, and the priority level information in the temporary subject information storage area.

An example of the configuration of the subject information table will be discussed below with reference to FIG. 9.

As discussed above, in the memory 32, the subject information storage area for storing subject information therein is reserved. The controller 30 stores a plurality of items of past subject information (OI_x) previously obtained from the contrast signal generator 15 in the subject information storage area in a table format. In the subject information storage area, a subject information table is formed. In the subject information table, number information, distance information, color signal value information, and priority level information are associated with each other for each of the magnification factors. In the number information, five numbers are stored for each magnification factor. In the distance information, the subject distance is stored. In the color signal value information, color signal values corresponding to R, G, and B are stored. In the priority level information, the priority level assigned to each subject is stored. In FIG. 9, the past subject information (OI_x) having the magnification factor “1” and the number “1” is indicated by the long dashed doted lines. There is a restricted number of items of past subject information that may be stored in this subject information table. In this embodiment, it is assumed that five items of past subject information may be stored for each magnification factor.

Before the controller 30 obtains subject information and optimizes the subject information in the subject information table, a user of the imaging apparatus 1 may store certain items of subject information in the subject information table in advance.

### (Processing for Storing Subject Information in Subject Information Storage Area)

Processing to be performed by the controller 30 when new subject information (NI) is stored in the temporary subject information storage area will now be discussed.

The purpose in storing subject information in the subject information storage area by the controller 30 is to reserve subject information concerning low contrast subjects focused by the focus lens group 5. Under the same environments, however, it is not always appropriate to reserve a plurality of similar items of subject information in the subject information storage area. This is because, if similar items of subject information continue to be stored in the subject information storage area, the subject information stored in the subject information storage area, as a whole, lacks versatility. For preventing such a situation, the controller 30 avoids storing subject information similar to subject information already stored in the subject information storage area while reserving subject information concerning low contrast subjects in the subject information storage area. In other words, only when new subject information read from the temporary subject information storage area is not similar to past subject information read from the subject information storage area, does the controller 30 store the new subject information in the subject information storage area by replacing the past subject information by the new subject information. In performing this processing, the controller 30 compares new subject information (NI) with past subject information (OI_x) in the following manner.

After storing new subject information (NI) in the temporary subject information storage area, the controller 30 first compares the new subject information (NI) with each of all items of past subject information (OI_x) stored in the subject information storage area in terms of the priority level, distance information, and color signal values. The controller 30 then judges whether each item of the past subject information (OI_x) in the subject information storage area will be replaced by the new subject information (NI) or the new subject information (NI) will be erased from the temporary subject information storage area without replacing a corresponding item of past subject information (OI_x) by the new subject information (NI).

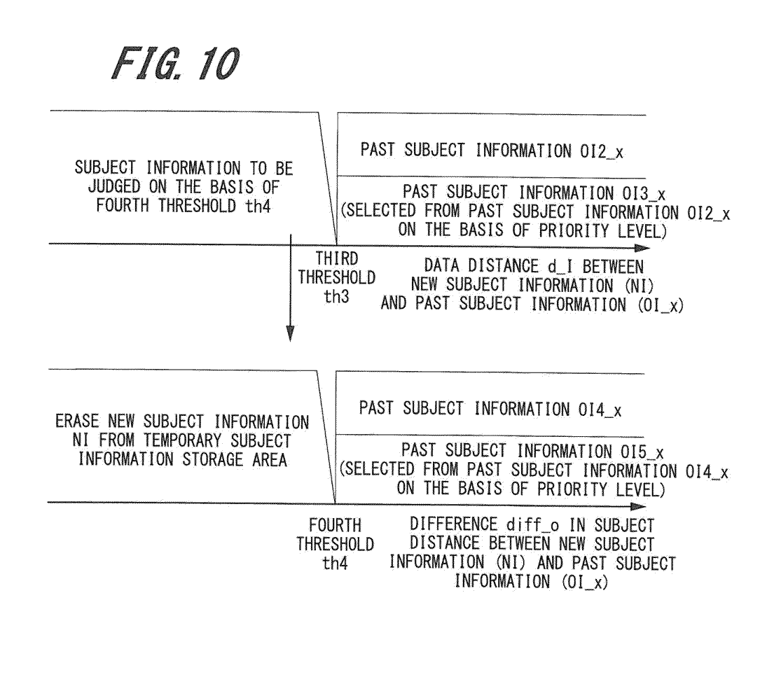

This judgement processing performed by the controller 30 will be discussed specifically below with reference to FIG. 10. FIG. 10 illustrates the relationship between a third threshold (th_3) and a fourth threshold (th_4) used for selecting subject information to be stored in the subject information storage area by the controller 30. In the following description, the third threshold (th_3) will be assumed as an example of a distance threshold, while the fourth threshold (th_4) will be assumed as an example of a distance difference threshold.

Upon detecting that new subject information is stored in the temporary subject information storage area, the controller 30 starts calculation processing. In this calculation processing, the controller 30 determines the data distance (d_I) (an example of data distance) between the color signal values contained in the new subject information (NI) and those in each item of the past subject information (OI_x) stored in the subject information storage area according to the following equation (1):

d_I=\sqrt{(Rn−Ro)²+(Gn−Go)²+(Bn−Bo)²} (1)

where Ry, Gy, and By respectively denote a red signal, a green signal, and a blue signal of the subject information. In equation (1), the subscript y is appended with n or o, where n is information concerning new subject information (NI) and o is information concerning past subject information (OI_x).
(Processing when Data Distance (d_I) is Equal to or Greater than Third Threshold (th_3))

The controller 30 then selects items of past subject information (OI2_x) for which the data distance (d_I) is calculated to be equal to or greater than the third threshold (th_3) from the items of past subject information (OI_x) in the subject information storage area. This selection processing is represented on a number line shown in the upper section of FIG. 10. On this number line, the third threshold (th_3) is indicated. The third threshold (th_3) is used for selecting past subject information (OI2_x) from the subject information storage area on the basis of the data distance (d_I) between the color signal values of new subject information (NI) and those of past subject information (OI_x). Processing for selecting subject information (OI2_x) from the subject information storage area by the controller 30 is performed for determining the similarity between the color features of the new subject information (NI) and those of the past subject information (OI_x).

Then, the controller 30 selects past subject information (OI3_x) from the selected items of past subject information (OI2_x) on the basis of the priority level set in each item of the past subject information (OI2_x). That is, the past subject information (OI2_x) includes past subject information (OI3_x). In this case, the controller 30 obtains priority information from each item of the past subject information (OI2_x) selected from the past subject information (OI_x) in the subject information storage area, and compares the priority level indicated by priority information concerning the new subject information (NI) with that of each item of the past subject information (OI2_x). As discussed above, the priority is higher in descending order of the first priority level, the second priority level, and the third priority level. Accordingly, the controller 30 selects past subject information (OI3_x) in which the priority level equal to or lower than that of the new subject information (NI) is set from the items of past subject information (OI2_x). For example, if the priority level of the new subject information (NI) is “2”, the controller 30 selects items of past subject information (OI2_x) having a priority level “2” or “3” as the past subject information (OI3_x).

The controller 30 determines that the new subject information (NI) having a priority level equal to or higher than that of the selected past subject information (OI3_x) will be stored in the subject information storage area. In this case, the controller 30 stores the new subject information (NI) in the subject information storage area by replacing an item of past subject information (OI3_x) having the smallest data distance (d_I2) by the new subject information (NI). The data distance (d_I2) concerning the color signal values is calculated by the controller 30 by using equation (1). The controller 30 then erases the item of past subject information (OI3_x) having the smallest data distance (d_I2) from the subject information storage area.

If it is determined that the priority levels of all items of past subject information (OI2_x) are the same as that of the new subject information (NI), the controller 30 erases the new subject information (NI) from the temporary subject information storage area. If it is determined that the priority levels of all items of past subject information (OI2_x) are higher than that of the new subject information (NI), the controller 30 also erases the new subject information (NI) from the temporary subject information storage area.

In this manner, by comparing the priority level of new subject information (NI) with that of past subject information (OI_x), the controller 30 is able to store subject information in the subject information storage area in descending order of first low contrast subjects, second low contrast subject, and auxiliary contrast subjects.

(Processing when Data Distance (d_I) is Smaller than Third Threshold (th_3))

Then, if the data distances (d_I) between the color signal values of items of past subject information (OI_x) and those of new subject information (IN) are all smaller than the third threshold (th_3), the controller 30 calculates the difference (diff_o) between the subject distance indicated by the new subject information (NI) and that indicated by each item of past subject information (OI_x).

On the number line shown in the lower section of FIG. 10, a fourth threshold (th_4) is indicated. The fourth threshold (th_4) is used for selecting, on the basis of the difference (diff_o) concerning the subject distance, subject information (OI3_x) from among items of past subject information (OI_x) for which the data distance (d_I) is calculated to be smaller than the third threshold (th_3).

Then, the controller 30 selects past subject information (OI4_x) for which the difference (diff_o) concerning the subject distance is calculated to be equal to or greater than the fourth threshold (th_4) from among items of past subject information (OI_x). In this manner, the controller 30 is able to select only items of past subject information (OI4_x) having a subject distance which is not similar to that of the new subject information (NI) from among the items of past subject information (OI_x) having color signal values similar to those of the new subject information (NI).

The controller 30 then obtains priority level information from each item of past subject information (OI4_x), and compares the priority level indicated by the priority level information of the new subject information (NI) with that of each item of past subject information (OI4_x). As a result of comparison, the controller 30 selects subject information having a priority level equal to or lower than that of the new subject information (NI) from among the items of past subject information (OI4_x) as subject information (OI5_x).

The controller 30 determines that the new subject information (NI) having a priority level equal to or higher than that of the selected past subject information (OI5_x) will be stored in the subject information storage area. In this case, the controller 30 stores the new subject information (NI) in the subject information storage area by replacing an item of past subject information (OI5_x) having the smallest data distance (d_I2) by the new subject information (NI). The data distance (d_I2) concerning the color signal values is calculated by the controller 30 by using equation (1). The controller 30 then erases the item of past subject information (OI5_x) having the smallest data distance (d_I2) from the subject information storage area.

If it is determined that the priority levels of all items of past subject information (OI4_x) are the same as that of the new subject information (NI), the controller 30 erases the new subject information (NI) from the temporary subject information storage area. If it is determined that the priority levels of all items of past subject information (OI4_x) are higher than that of the new subject information (NI), the controller 30 also erases the new subject information (NI) from the temporary subject information storage area.

If the differences in the subject distance between all items of past subject information (OI4_x) and the new subject information (NI) are smaller than the fourth threshold (th_4), the controller 30 also erases the new subject information (NI) from the temporary subject information storage area.

According to the above-described rules, the controller 30 selects subject information to be reserved in the subject information storage area. It is thus possible to perform optimizing processing for reserving subject information that is appropriate for imaging low contrast subjects by the imaging apparatus 1. Accordingly, unlike known techniques, the controller 30 is able to avoid reserving subject information which is unnecessary for focusing on a low contrast subject, that is, a subject for which ranging is not achieved. Moreover, when performing AF operation, the controller 30 only refers to subject information which is suitable for a currently imaging subject from the subject information storage area. This makes it possible to decrease the time taken to focus the focus lens group 5 on a low contrast subject, and also, it makes it easy to focus the focus lens group 5 on a low contrast subject.

### (Flowchart of AF Operation)

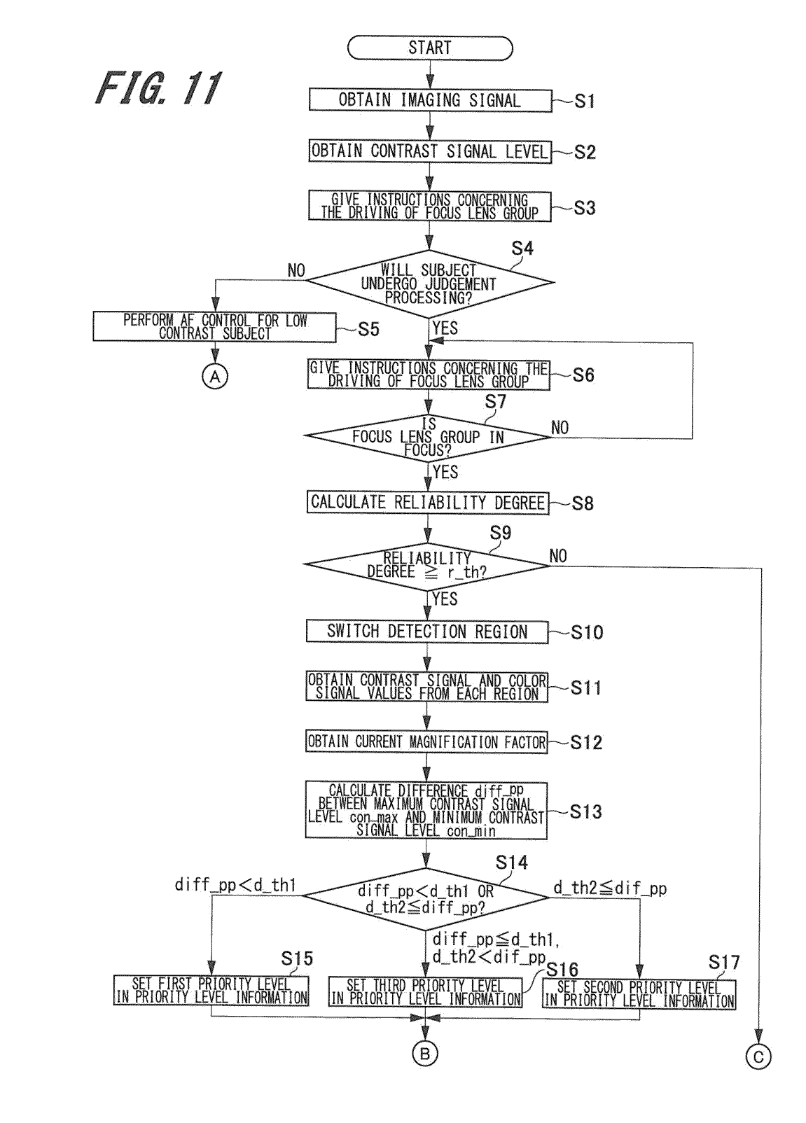

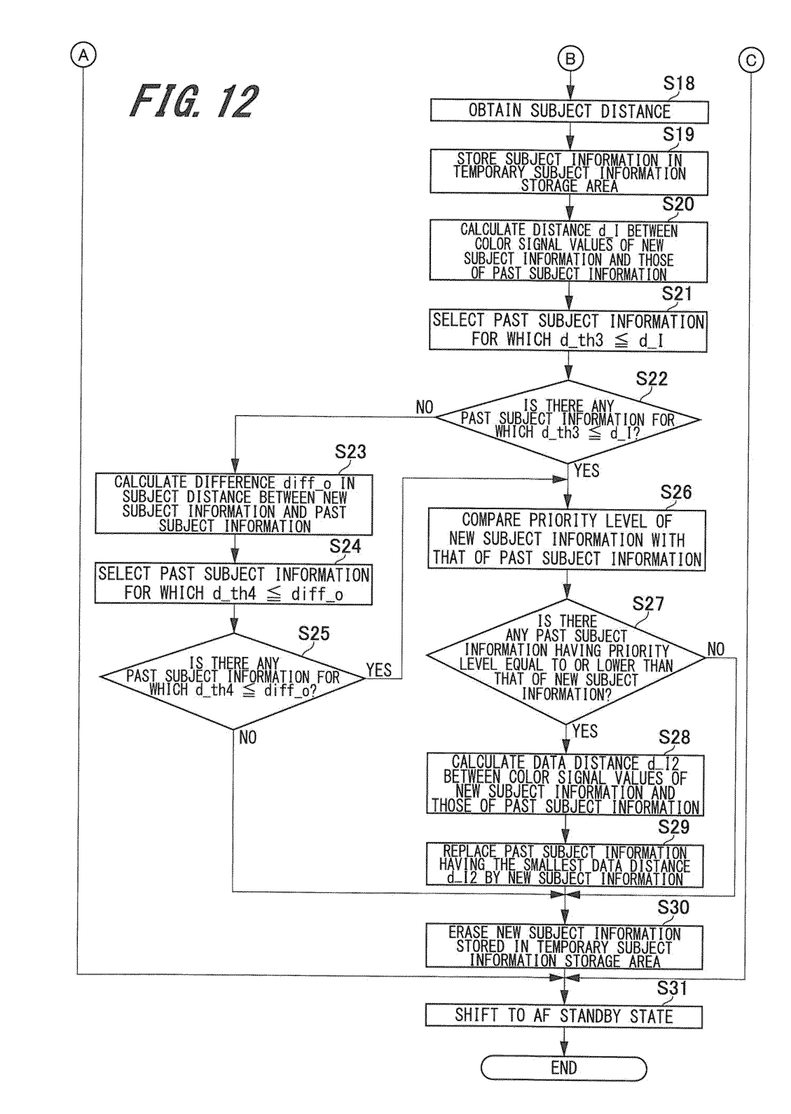

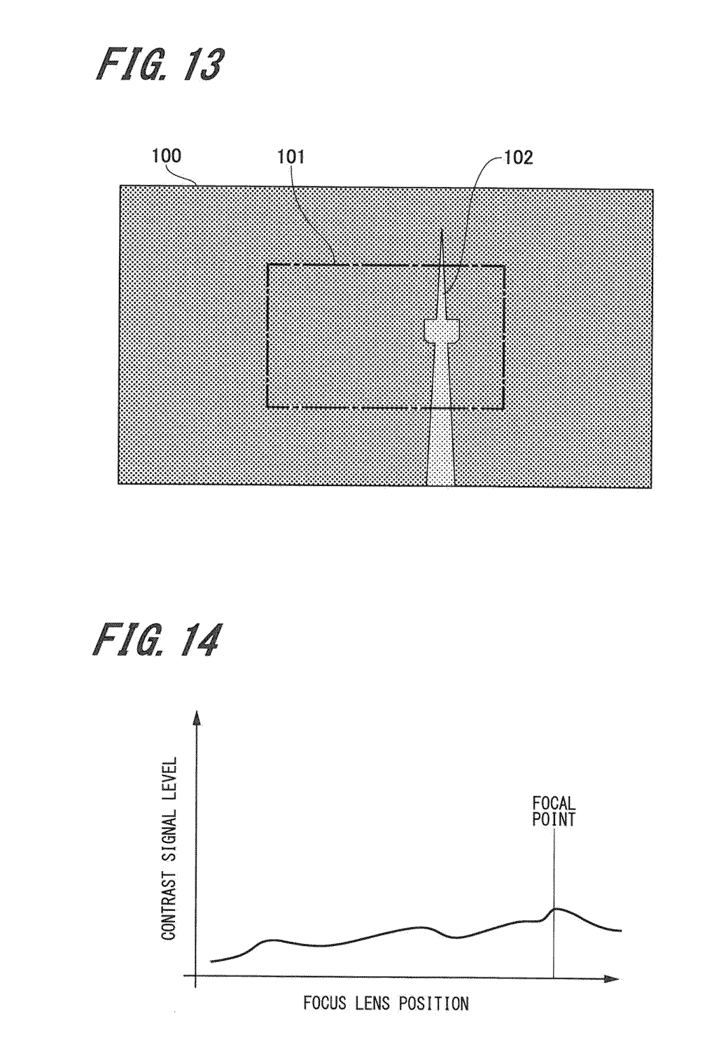

FIGS. 11 and 12 are flowcharts illustrating an example of AF operation performed by the imaging apparatus 1. This processing is a processing sequence obtained as a result of the controller 30 executing a program stored in the memory 32 of the imaging apparatus 1.

When the imaging apparatus 1 is powered ON or the subject is changed, the controller 30 starts AF control processing and shifts to AF operation.

In step S1, the controller 30 drives the electronic shutter 47 and exposes the imaging element 8 to light so as to cause the imaging element 8 to generate and output an imaging signal. Then, in step S2, the controller 30 obtains a contrast signal level on the basis of a contrast signal output from the camera signal processor 13.

Then, in step S3, the controller 30 gives instructions concerning the driving of the focus lens group 5 on the basis of the contrast signal level obtained in step S2. In this case, the controller 30 determines in step S4 whether or not a currently imaging subject will undergo judgement processing starting from step S6, on the basis of the contrast signal obtained from the first detection region 51 shown in FIG. 2.

If it is determined in step S4 that the subject will not undergo the judgement processing starting from step S6, the controller 30 proceeds to step S5. In step S5, the controller 30 performs AF control for a low contrast subject. The AF control is processing for selecting necessary items of subject information from past subject information (OI_x) stored in the subject information storage area according to certain rules. The controller 30 then proceeds to step S31. In step S31, the controller 30 enters the AF standby state.

If it is determined in step S4 that the subject will undergo the judgement processing starting from step S6, the controller 30 proceeds to step S6. In step S6, the controller 30 continues to give instructions concerning the driving of the focus lens group 5. In this case, the controller 30 gives instructions concerning the driving of the focus lens group 5 by using the contrast AF method, and tries to focus the focus lens group 5 on the currently imaging subject.

The controller 30 then determines in step S7 whether or not the focus lens group 5 is currently in focus, that is, whether or not the focus lens group 5 has stopped at the focusing position, on the basis of the focus lens position and the contrast signal obtained from the camera signal processor 13. If it is determined in step S7 that the focus lens group 5 is in focus, the controller 30 proceeds to step S8. In step S8, the controller 30 calculates the above-described reliability degree from the current contrast signal level and the time taken for the focus lens group 5 to reach the focusing position. If the time taken for the focus lens group 5 to reach the focusing position is long, it means that the controller 30 has not found the peak of the contrast signal level, and thus, the reliability degree is calculated to be low.

The controller 30 then determines in step S9 whether or not the reliability degree calculated in step S8 is equal to or greater than the reliability degree threshold (r_th) read from the memory 32. If the reliability degree is found to be smaller than the reliability degree threshold (r_th) in step S9, the controller 30 proceeds to step S31. In step S31, the controller 30 enters the AF standby state. In the AF standby state, AF operation is not performed until there is a change in subject information, and when the subject information has changed, AF operation is started.

If the reliability degree is found to be equal to or greater than the reliability degree threshold (r_th) in step S9, the controller 30 proceeds to step S10. In step S10, the controller 30 instructs the contrast signal generator 15 of the camera signal processor 13 to switch the first detection region 51 to the nine second detection regions 52a through 52i shown in FIG. 3. Then, in step S11, the controller 30 obtains contrast signals and color signal values of the individual second detection regions 52a through 52i from the contrast signal generator 15. In step S12, the controller 30 obtains the current magnification factor on the basis of the position of the variator lens group 3 at the time point when the controller 30 has obtained the contrast signals and the color signal values in step S11.

Then, in step S13, the controller 30 calculates the difference (diff_pp) in the contrast signal level. The difference (diff_pp) is a value obtained by subtracting the minimum contrast signal level (con_min) from the maximum contrast signal level (con_max) among the contrast signal levels obtained from the second detection regions 52a through 52i.

Then, in step S14, the controller 30 compares the difference (diff_pp) in the contrast signal level with the first threshold (d_th1) and the second threshold (d_th2), which is greater than the first threshold (d_th1), as shown in FIG. 7. If the difference (diff_pp) is found to be smaller than the first threshold (d_th1) in step S14, the controller proceeds to step S15. In step S15, the controller 30 sets the first priority level in the priority level information to be included in subject information concerning the currently imaging subject.

If the difference (diff_pp) is found to be equal to or greater than the second threshold (d_th2) in step S14, the controller proceeds to step S17. In step S17, the controller 30 sets the second priority level in the priority level information to be included in subject information concerning the currently imaging subject. If the difference (diff_pp) is found to be equal to or greater than the first threshold (d_th1) and is smaller than the second threshold (d_th2) in step S14, the controller proceeds to step S16. In step S16, the controller 30 sets the third priority level in the priority level information to be included in subject information concerning the currently imaging subject. Then, in step S18, on the basis of the current focus lens position, the controller 30 obtains the subject distance of the currently focusing subject from the distance information table stored in the memory 32.

Then, in step S19, the controller 30 combines the color signal values obtained in step S11, the priority level information set in one of steps S15 through S17, and the subject distance obtained in step S18 into subject information. The controller 30 then stores this subject information in the temporary subject information storage area of the memory 32.

Then, in step S20, the controller 30 refers to the subject information stored in the temporary subject information storage area as new subject information (NI), and compares the new subject information (NI) with past subject information (OI_x) stored in the subject information storage area. The controller 30 first extracts the color signal values from the new subject information (NI) and those from each item of past subject information (OI_x), and then calculates the data distance (d_I) between the color signal values of the new subject information (NI) and those of each item of past subject information (OI_x) by using equation (1). Then, in step S21, the controller 30 selects past subject information (OI2_x) for which the data distance (d_I) is calculated to be equal to or greater than the third threshold (d_th3) from the items of past subject information (OI_x) in the subject information storage area. The controller 30 determines in step S22 whether or not there is such an item of past subject information (OI2_x) among the items of past subject information (OI_x).

If it is determined in step S22 that there is no item of past subject information (OI2_x) for which the data distance (d_I) is calculated to be equal to or greater than the third threshold (d_th3) in the subject information storage area, the controller 30 proceeds to step S23. In step S23, the controller 30 calculates the difference (diff_o) concerning the subject distance. The difference (diff_o) is calculated by subtracting the subject distance of past subject information (OI_x) from that of the new subject information (NI). Then, in step S24, the controller 30 selects past subject information (OI4_x) for which the difference (diff_o) is calculated to be equal to or greater than the fourth threshold (d_th4) from the items of past subject information (OI_x) in the subject information storage area. The controller 30 determines in step S25 whether or not there is such an item of past subject information (OI4_x) among the items of past subject information (OI_x). If it is determined in step S25 that there is no item of past subject information (OI4_x) for which the difference (diff_o) is calculated to be equal to or greater than the fourth threshold (d_th4) in the subject information storage area, the controller 30 proceeds to step S30. In step S30, the controller 30 erases the new subject information (NI) stored in the temporary subject information storage area. Then, in step S31, the controller 30 enters the AF standby state.

If it is determined in step S22 that there is past subject information (OI2_x) for which the data distance (d_I) is calculated to be equal to or greater than the third threshold (d_th3), or if it is determined in step S25 that there is past subject information (OI4_x) for which the difference (diff_o) is calculated to be equal to or greater than the fourth threshold (d_th4), the controller 30 proceeds to step S26. In step S26, the controller 30 compares the priority level of the new subject information (NI) with that of the past subject information (OI2_x or OI4_x). Then, the controller 30 determines in step S27 whether or not there is past subject information (OI2_x or OI4_x) in which a priority level equal to or lower than that of the new subject information (NI) is set.

If it is determined in step S27 that there is no past subject information (OI2_x or OI4_x) in which a priority level equal to or lower than that of the new subject information (NI) is set, the controller 30 proceeds to step S30. In step S30, the controller 30 erases the new subject information (NI) stored in the temporary subject information storage area. Then, in step S31, the controller 30 enters the AF standby state.

If it is determined in step S27 that there is past subject information (OI2_x or OI4_x) in which a priority level equal to or lower than that of the new subject information (NI) is set, the controller 30 selects, from the past subject information (OI2_x or OI4_x), past subject information (OI3_x or OI5_x) in which a priority level equal to or lower than that of the new subject information (NI) is set. Then, in step S28, the controller 30 calculates the data distance (d_I2) between the color signal values of the new subject information (NI) and those of the selected past subject information (OI3_x or OI5_x).

Then, in step S29, the controller 30 erases an item of past subject information (OI3_x or OI5_x) having the smallest data distance (d_I2) from the subject information storage area, and stores the new subject information (NI) in the subject information storage area. Then, in step S30, the controller 30 erases the new subject information (NI) from the temporary subject information storage area. In step S31, the controller 30 enters the AF standby state.

The imaging apparatus 1 of the above-described embodiment is able to perform suitable AF control when imaging a low contrast subject or imaging a subject under low contrast environments. Accordingly, even for a subject for which ranging is difficult to achieve, the imaging apparatus 1 is able to drive a focus lens group to a suitable position and to focus the focus lens group on the subject.

After the controller 30 has stopped AF operation for a subject for which ranging is achieved, it classifies the subject into one of the categories on the basis of contrast signal levels obtained from the second detection regions 52a through 52i, and sets one of the first through third priority levels in subject information of the subject. The first through third priority levels are priority levels at which subjects will be stored in the subject information storage area. Accordingly, subject information in which a higher priority level is set is preferentially stored in the subject information storage area. As a result, the imaging apparatus 1 is able to read useful subject information from the subject information storage area so as to image a low contrast subject at a suitable focus lens position.

If the number of items of subject information stored in the subject information storage area in the memory 32 exceeds a predetermined restricted number, the controller 30 performs optimizing processing for the subject information storage area. In this optimizing processing, if new subject information stored in the temporary subject information storage area is similar to past subject information stored in the subject information storage area, the new subject information is not stored in the subject information storage area. Additionally, if the priority level of new subject information is equal to or lower than that of past subject information, the new subject information is not stored in the subject information storage area. In this manner, the number of items of past subject information stored in the subject information storage area is optimized, so that it is possible to prevent unnecessary subject information from being stored in the subject information storage area.

### (3) Other Embodiments

In the above-described embodiment, the present invention is applied to the imaging apparatus 1 configured as shown in FIG. 1 as an example. However, the invention is not restricted to the imaging apparatus 1, and may be widely applicable to imaging apparatuses configured in various manners.

For example, under the control of the controller 30, the contrast signal generator 15 may change the positions of the first detection region 51 and the second detection regions 52a through 52i, and/or increase or decrease the number of first detection region 51 and second detection regions 52a through 52i. Second detection regions may be divided from the first detection region 51. In the above-described embodiment, the first detection region 51 is switched to the nine second detection regions 52a through 52i. However, the number of second detection regions is not restricted as long as there are two or more second detection regions within the imaging area 50. Additionally, second detection regions may overlap each other or may be configured in a shape other than a rectangle. That is, detection regions may be set as desired within a certain range of area so that the differences in the color signal values and in the contrast can be checked. By setting the number, position, and size of detection regions in accordance with certain conditions, such as the type and size of a subject to be imaged and the estimated position at which the subject may be located within a captured image, it is possible to focus a target subject more precisely.

If there are multiple peaks of a contrast signal level of a subject, which can be a focal point, within a detection region and if such peaks are substantially the same value, the difference in the contrast signal level becomes small. In this case, it is possible that the controller 30 incorrectly recognize this subject as a first low contrast subject. For avoiding such incorrect recognition, a level threshold may be set for a contrast signal level, and if each peak of a contrast signal level is equal to or greater than the level threshold, the controller 30 determines that this subject is not a low contrast subject. This makes it possible to avoid a situation where the controller 30 incorrectly recognizes that a subject having a high contrast signal level is a low contrast subject.

The data distance (d_I) between the color signal values of new subject information (NI) and those of past subject information (OI_x) stored in the subject information storage area is determined on the basis of the RGB values of a color image. Alternatively, the data distance (d_I) may be determined on the basis of the luminance value of a monochromatic image. In the case of a monochromatic image, as well as in the case of a color image, the controller 30 performs control so that similar images will not be stored in the subject information storage area so as to effectively utilize the subject information storage area in the memory 32.

In the subject information table shown in FIG. 9, five items of subject information are stored for each magnification factor. However, the number of items of subject information stored in the subject information table is not restricted. The subject information table may be modified, for example, in the following manner. A certain range of magnification factors may be specified, and the same subject information may be used for subjects to be imaged within this range of magnification factors.

The controller 30 compares subject information concerning a currently imaging subject with past subject information stored in the subject information storage area, on the basis of the data distance concerning the color signal values calculated by equation (1). However, in order to obtain the features of subjects, a different type of signal other than color signal values, for example, a contrast signal or a luminance signal, may be used, in which case, advantages similar to those obtained by the use of color signal values may be obtained. In this case, it is desirable to utilize a different mathematical expression for determining the similarity between subject information concerning a currently imaging subject and past subject information.

If the number of items of past subject information (OI_x) stored in the subject information storage area in the memory 32 exceeds a predetermined restricted number, the controller 30 may erase an item of subject information that has been checked least frequently so far or that was stored in the earliest time among the items of past subject information (OI_x), and may store new subject information (NI) in the subject information storage area instead of the erased item of subject information.

The present invention is not restricted to the above-described embodiments, and various other applications and modifications may be made without departing from the scope of the claims.

For example, in the above-described embodiments, the configurations of the apparatus and system are described in detail and specifically for easy understanding of the present invention. It is not always necessary that the apparatus or system have all the elements and configurations discussed in the embodiments. Additionally, part of the configuration of one embodiment may be replaced by the configuration of another embodiment, and the configuration of one embodiment may be added to that of another embodiment. Part of the configuration of each embodiment may be deleted or replaced by another configuration. Another configuration may also be added to part of the configuration of each embodiment.

Concerning control lines and information lines, those that may be necessary for the description of the invention only are shown, and not all control lines and information lines of an actual product are shown. As a matter of fact, almost all the elements and configurations are interconnected in the actual product.

1. A focus control device comprising:
a driving unit that drives a focus lens to focus a subject;
a signal generator that generates a contrast signal for each of a plurality of detection regions set within an imaging area of an imaging unit from an imaging signal corresponding to each of the plurality of detection regions, the imaging signal being output as a result of the imaging unit imaging an optical image of the subject which is formed in the imaging unit via the focus lens; and
a controller that sets the plurality of detection regions within the imaging area, compares a difference in a contrast signal level between a maximum contrast signal level and a minimum contrast signal level calculated from among contrast signal levels of the contrast signals generated for the plurality of detection regions with a level difference threshold, sets a priority level in subject information concerning the subject on the basis of a comparison result, stores the subject information in a storage unit in accordance with the priority level set in the subject information, and controls the driving unit on the basis of the subject information read from the storage unit so as to bring the focus lens into focus.

2. The focus control device according to claim 1, wherein, if the difference in the contrast signal level is smaller than the level difference threshold, the controller sets a higher priority level in the subject information, and if the difference in the contrast signal level is equal to or greater than the level difference threshold, the controller sets a lower priority level in the subject information, and the controller preferentially stores subject information in which the higher priority level is set in the storage unit.

3. The focus control device according to claim 2, wherein:
the level difference threshold includes a first level difference threshold and a second level difference threshold, the second level difference threshold being greater than the first level difference threshold;
if the difference in the contrast signal level is smaller than the first level difference threshold, the controller sets a first priority level in the subject information, if the difference in the contrast signal level is equal to or greater than the second level difference threshold, the controller sets a second priority level, which is lower than the first priority level, in the subject information, and if the difference in the contrast signal level is equal to or greater than the first level difference threshold and is smaller than the second level difference threshold, the controller sets a third priority level, which is lower than the second priority level, in the subject information.

4. The focus control device according to claim 3, wherein:
in the storage unit, a temporary subject information storage area in which new subject information concerning a subject newly obtained by the controller from the signal generator is stored and a subject information storage area in which past subject information previously obtained by the controller from the signal generator is stored are disposed; and
if the new subject information read from the temporary subject information storage area is not similar to the past subject information read from the subject information storage area, the controller stores the new subject information in the subject information storage area by replacing the past subject information by the new subject information.

5. The focus control device according to claim 4, wherein the controller calculates a data distance between the new subject information and the past subject information, and, if the data distance is equal to or greater than a distance threshold and if the priority level set in the new subject information is equal to or higher than the priority level set in the past subject information, the controller stores the new subject information in the subject information storage area by replacing an item of the past subject information for which the data distance is calculated to be the smallest by the new subject information.

6. The focus control device according to claim 4, wherein the controller calculates a data distance between the new subject information and the past subject information, and, if the data distance is smaller than a distance threshold, the controller calculates a difference in a subject distance between the new subject information and the past subject information, and, if the difference in the subject distance is equal to or greater than a distance difference threshold and if the priority level set in the new subject information is equal to or higher than the priority level set in the past subject information, the controller stores the new subject information by replacing an item of the past subject information for which the data distance is calculated to be the smallest by the new subject information.

7. The focus control device according to claim 6, wherein, in the subject information storage area, as past records concerning focusing of the focus lens, a predetermined number of items of information concerning a color signal value or a luminance value, the subject distance, and the priority level are stored for each magnification factor as the past subject information, and subject information concerning a subject which is highly likely to have been focused by the focus lens and is highly likely to be a low contrast subject is preferentially stored in the subject information storage area.

8. The focus control device according to claim 1, wherein the storage unit is included in the focus control device or is disposed outside of the focus control device.

9. An imaging apparatus comprising:
a driving unit that drives a focus lens to focus a subject;
an imaging unit that outputs an imaging signal by imaging an optical image of the subject which is formed in the imaging unit via the focus lens;
a signal generator that generates a contrast signal for each of a plurality of detection regions set within an imaging area of the imaging unit from the imaging signal corresponding to each of the plurality of detection regions; and
a controller that sets the plurality of detection regions within the imaging area, compares a difference in a contrast signal level between a maximum contrast signal level and a minimum contrast signal level calculated from among contrast signal levels of the contrast signals generated for the plurality of detection regions with a level difference threshold, sets a priority level in subject information concerning the subject on the basis of a comparison result, stores the subject information in a storage unit in accordance with the priority level set in the subject information, and controls the driving unit on the basis of the subject information read from the storage unit so as to bring the focus lens into focus.

10. A focus control method comprising:
generating a contrast signal for each of a plurality of detection regions set within an imaging area of an imaging unit from an imaging signal corresponding to each of the plurality of detection regions, the imaging signal being output as a result of the imaging unit imaging an optical image of a subject which is formed in the imaging unit via a focus lens;
comparing a difference in a contrast signal level between a maximum contrast signal level and a minimum contrast signal level calculated from among contrast signal levels of the contrast signals generated for the plurality of detection regions with a level difference threshold and setting a priority level in subject information concerning the subject on the basis of a comparison result; and
storing the subject information in a storage unit in accordance with the priority level set in the subject information and driving the focus lens on the basis of the subject information read from the storage unit so as to focus the focus lens on the subject.
